(19) United States
(12) Patent Application Publication
(10) Pub. No.: US 2012/0306816 A1
(43) Pub. Date: Dec. 6, 2012

(54) Simplified Optical Position Sensing Assembly

(76) Inventor: Simon James Bridger, Auckland (NZ)

(21) Appl. No.: 13/153,910

(22) Filed: Jun. 6, 2011

(51) Int. Cl. G06F 3/042; B29D 11/00; G01J 1/04; H01J 40/14; G01J 5/02

(52) U.S. Cl. 345/175; 250/221; 250/353; 250/227.11; 264/1.7

(57) ABSTRACT

The present invention relates to a simplified optical position sensing assembly, which includes a unitized optical assembly formed as a single component and a unitized optical circuit. The unitized optical assembly is attached or mounted to the unitized optical circuit. The unitized optical assembly may include a body and a single-element lens. The single-element lens can be injection-molded within a first cavity of the body so as to form a single component. An illumination window may be received within a second cavity extending from the back to the front of the body. The unitized optical circuit can include an energy source and a sensor directly connected thereto. The present invention also relates to an optical position sensing system incorporating such a simplified optical position sensing assembly and methods for manufacturing a unitized optical assembly.

### TECHNICAL FIELD

The present invention relates generally to electronic sensors, and more particularly to optical position sensors, such as those used in connection with touch sensitive screens.

### BACKGROUND

Optical position sensing systems are commonly used to provide “touch screen” capabilities in connection with computer displays, office machinery, gaming equipment, etc. FIG. 1 depicts an exemplary optical position sensing system 100. Optical position sensing systems, like the one illustrated in FIG. 1, can use a combination of electromagnetic radiation, reflectors (or other light guides), image and/or line-scan sensors, digital signal processing, and algorithms to determine the position of a pointer within a viewing area. Optical position sensing system 100 thus includes the hardware and software components that provide position sensing or touch detection.

The exemplary optical position sensing system 100 may include a display 110. One or more optical position sensing assemblies 130 may be attached to the display 110. In some embodiments, one or more optical position sensing assemblies 130 may be mounted to an overlay positioned over the display 110. In other embodiments, one or more optical position sensing assemblies 130 may be mounted to the surface of the display 110 itself. Each optical position sensing assembly 130 can include an energy source, such as a light emitting diode (“LED”), and a sensor, and other optical components, such as an imaging lens, imaging window, an infrared filter, and an LED lens or window. Energy sources housed in optical position sensing assemblies 130 can emit electromagnetic radiation 140, such as ultraviolet, visible or infrared light, into the viewing area of the display 110.

A bezel 105 may border the viewing area of the display 110. The electromagnetic radiation 140 may be guided throughout the viewing area by reflective members, such as reflectors 107, applied to the bezel 105. In some embodiments, the reflectors 107 comprise retroreflective material, such as film, tape or paint. Retroreflective material can be a “glass bead” material, which has a surface formed by a layer of tiny transparent spheres (i.e., glass beads). Retroreflective material can also be “prismatic” material, which includes an embedded layer of metalized triangular cube corner elements.

The electromagnetic radiation 140 can thus “illuminate” the viewing area of the display 110. A disruption of the illumination (for example, by a finger) can be detected by optical position sensing assembly 130. Optical position sensing assemblies 130 can transmit data regarding variations in the electromagnetic radiation 140 to a processing unit 150. The processing unit 150 can execute software for processing said data and calculating the location of a touch relative to the display 110. The processing unit 150 may be any type of processor-driven device, such as a personal computer, a laptop computer, a touch screen controller, a digital signal processor, etc. These and other types of processor-driven devices will be apparent to those of skill in the art. The term “processor” can refer to any type of programmable logic device, including a microprocessor or any other type of similar device. The optical position sensing system 100 can thus enable a user to view and interact with visual output presented on the display 110.

Conventional optical position sensing assemblies 130 are constructed using multiple separate components. Certain components allow the entry and refraction of illumination into the optical position sensing assembly 130. These components include an aperture plate in which an aperture is defined, a lens, and an imaging window, all of which must be properly aligned. As mentioned, a typical optical position sensing assembly 130 also includes an image sensor or a line scan sensor (generically referred to hereinafter as a “sensor”) and an energy source. The sensor and energy source components are typically separate components connected via a flexible printed circuit board.

Constructing an optical position sensing assembly 130 using multiple separate components increases the complexity, and therefore adds to the cost, of manufacturing. Using multiple components also adds unwanted space, thereby increasing the size of the optical position sensing assembly 130. Furthermore, a multi-component optical position sensing assembly 130 is more difficult to make water-proof or otherwise seal. An optical position sensing assembly 130 that is not properly sealed is vulnerable to penetration by moisture and other contaminants, which can disrupt the refractive properties required for proper lens and sensor operation.

Moreover, in the design of conventional optical position sensing assemblies 130, the aperture is spaced away from the lens component. This leaves a void in the aperture and an open volume between the lens surface and the aperture. This spacing between the aperture and the lens is particularly susceptible to contaminants, such as liquids and dust. For example, contaminants can be pushed into the spacing between the aperture and the lens when one tries to wipe the lens clean. To avoid this problem, conventional optical position sensing assemblies 130 will include either a separate front window for the sensor lens or a front lens element of a two element lens design.

Accordingly, it is desirable to develop an optical position sensing assembly that is constructed from a minimal number of separate components, provides a sealed design to minimize the ingress of contaminants, and provides a wipe-able lens design.

### SUMMARY

The present invention meets the above described needs and satisfies the above described problems by providing a simplified optical position sensing assembly that includes a unitized optical assembly formed as a single component and a unitized optical circuit. The unitized optical assembly is attached or mounted to the unitized optical circuit. Embodiments of the invention may include one or more of the following features.

The unitized optical assembly may include a body, formed from opaque material, and a single-element lens. The body may be molded so as to define at least one cavity and an aperture. The single-element lens can be injection-molded within the cavity of the body so as to form a single component. The single-element lens can be formed from a material suitable for chemically bonding to the opaque material. The single-element lens may fill the body cavity so as to form an imaging lens surface that is substantially flush with the aperture of the optical sensing assembly. The imaging lens surface can treated with a hard coating film. The body may include a second cavity for receiving an illumination window that extends from the back to the front of the body.

In some embodiments, the unitized optical circuit can include an energy source and a sensor directly connected to the energy source without using an intermediate printed circuit board. The energy source can be positioned at an offset to the axis centered on and perpendicular to the aperture. When the unitized optical assembly is attached or mounted to the unitized optical circuit, the illumination window is positioned between the energy source and a front plane of the optical position sensing assembly. The refractive properties of the illumination window foreshorten the apparent distance between the energy source and the front plane of the optical position sensing assembly. In some embodiments, the illumination window can be formed into a light pipe. The light pipe can be designed to emit light at the front plane of the optical position sensing assembly in an illumination pattern of substantially 90 degrees.

In some embodiments, the unitized optical assembly may include a dyed portion of the single-element lens that can block visible light and pass infrared light. In other embodiments, the hard coating film of the imaging lens surface can be coated with a substance that can block visible light and pass infrared light. In other embodiments, the sensor may be coated with a substance that can block visible light and pass infrared light.

In some embodiments, the optical position sensing assembly may be disposed in an optical position sensing system. An optical position sensing system can include a touch area and an optical position sensing assembly adjacent the touch area. The optical position sensing assembly can be configured to detect interference with energy traveling in the touch area. The optical position sensing assembly can include the unitized optical assembly, an energy source and a sensor. The energy source and the sensor may be mounted on a unitized optical circuit attached or mounted to the unitized optical assembly.

The optical position sensing system may also include a frame located around a perimeter of the touch area and at least one reflector mounted on the frame for reflecting energy across the touch surface. The optical position sensing assembly may be mounted to the frame and can be configured to detect interference with energy emitted from the energy source into the touch area and reflected by the at least one reflector. The optical position sensing system may also include a computing system comprising a processing unit. The processing unit can be interfaced to the optical position sensing assembly. The processing unit can be configured to determine a position of a touch in the touch area.

Embodiments of the present invention may also include a method for manufacturing a unitized optical assembly. The method can include injection molding a body using an opaque material, such that at least a portion of the body defines an aperture and a cavity for receiving a single-element lens. A single-element lens can be injection-molded within the cavity of the body so as to form a single component. The single-element lens may be made from a lens material suitable for chemically bonding to the opaque material and the single-element lens may fill the cavity so as to create an imaging lens surface substantially flush with the aperture. The molded body may further define a second cavity for receiving an illumination window. The method may therefore include injection-molding the illumination window in the second cavity such that the illumination window extends from the back to the front of the body. The injection-molding steps can be performed as a two shot molding process or as an insert molding process. During injection-molding, the single-element lens can be appropriately dyed to act as an infrared pass filter.

### BRIEF DESCRIPTION OF THE DRAWINGS

FIG. 1 is an illustration of a conventional optical position sensing system.

FIG. 2, comprising FIGS. 2a, 2b and 2c, shows different views of a simplified optical position sensing assembly according to certain exemplary embodiments of the present invention.

FIG. 3 is a cross-sectional view of the simplified optical position sensing assembly shown in FIG. 2.

FIG. 4 is an illustration of a simplified optical position sensing assembly according to certain alternative embodiments of the present invention.

FIG. 5 is a cross-sectional view of the simplified optical position sensing assembly shown in FIG. 4.

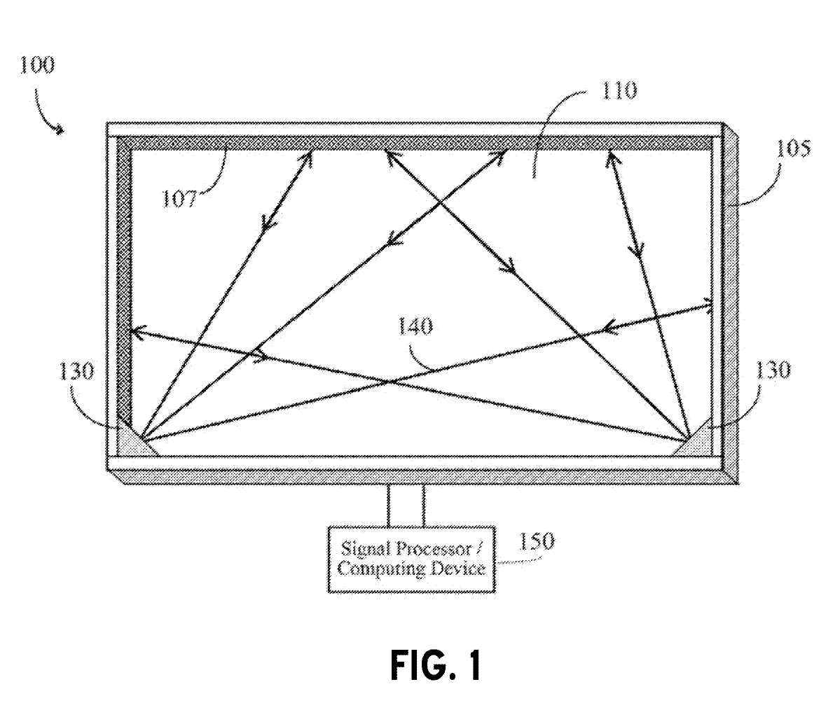

### DETAILED DESCRIPTION

The present invention provides a design for a simplified optical position sensing assembly that may include a unitized optical assembly and a unitized optical circuit. The unitized optical assembly is manufactured as a single component, with optically active transparent elements, including a single element lens, being co-molded or twin-shot molded with opaque body elements. The unitized optical circuit can include a sensor and an energy source on a single multi-chip module. In some embodiments, the single element lens can be dyed or coated with a material allowing the single element lens to function as an infrared pass filter. In other embodiments, overmolding applied to the unitized optical circuit can be dyed so as to provide an infrared pass filter function. In some embodiments, the simplified optical position sensing assembly may be disposed in an optical position sensing system. The present invention also provides a method of manufacturing a unitized optical assembly.

Each of the following examples is provided by way of explanation only, and not as a limitation of the scope of invention. It will be apparent to those skilled in the art that modifications and variations can be made without departing from the scope or spirit of the present disclosure and the appended claims. For instance, features illustrated or described as part of one embodiment of the invention may be used in connections with another embodiment to yield a still further embodiment. Thus, it is intended that the present disclosure includes any and all modifications and variations as come within the scope of the appended claims and their equivalents.

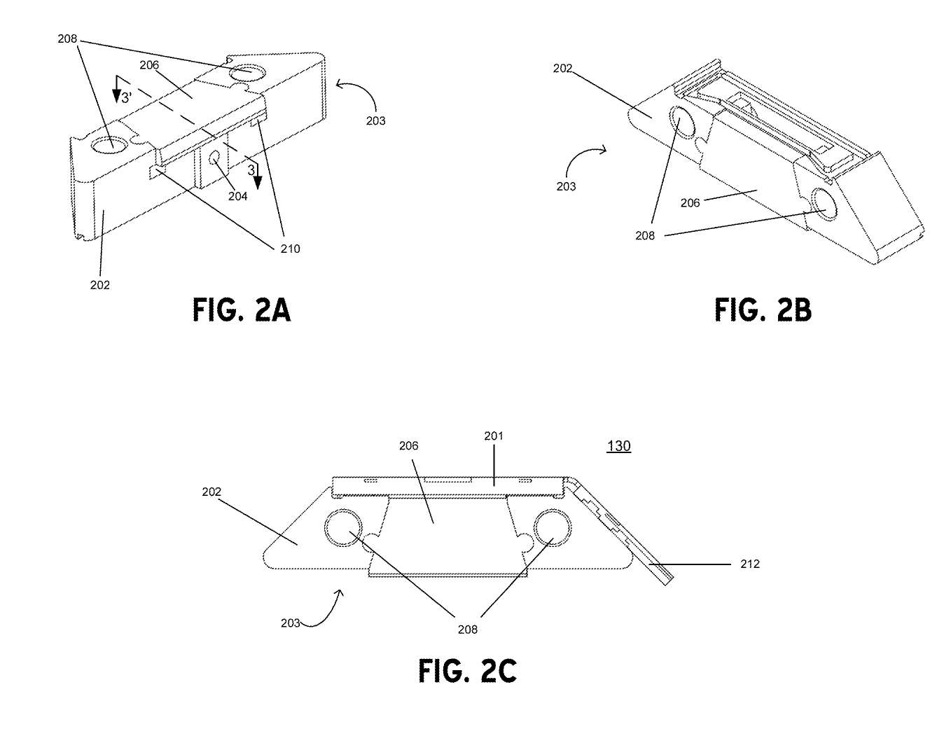

FIGS. 2a, 2b and 2c show different views of an exemplary optical position sensing assembly 130 according to certain embodiments of the invention. The optical position sensing assembly 130 includes a unitized optical circuit 201 and a unitized optical assembly 203. As will be described below, the unitized optical circuit 201 includes an energy source (not shown) for emitting electromagnetic radiation 140 and a sensor (not shown) for detecting electromagnetic radiation 140. The energy source and sensor may be mounted on a lead frame (not shown), which may be coupled to a lead frame connector 212. As is known in the art, a lead frame connector 212 can be used to communicatively couple the optical position sensing assembly 130 to an optical position sensing system 100. In some embodiments, the lead frame connector 212 can be one or more copper wire pins extending from an etched copper lead frame.

The unitized optical assembly 203 includes a body 202, an aperture 204, an illumination window 206, and a lens (not shown). The aperture 204 allows reflected electromagnetic radiation 140 to enter the interior of optical position sensing assembly 130 for detection by the sensor. The illumination window 206 allows electromagnetic radiation 140 emitted by the energy source to emanate from the optical position sensing assembly 130. The aperture 204, illumination window 206 and lens can be all defined in the body 202 during manufacture, as will be described below. The body 202 of the unitized optical assembly 203 may be constructed of an opaque plastic or thermoplastic material (e.g., acrylic, Plexiglass, polycarbonate, etc.).

The optical position sensing assembly 130 can be attached to a display 110 or to an overlay or other component of an optical position sensing system 100 at a position suitable for the operation of the optical position sensing system 100. The optical position sensing assembly 130 can be attached by any suitable means, such as screws, bolts, clips or other mechanical fasteners, adhesives, etc. In some embodiments, the body 202 of the unitized optical assembly can include mounting holes 208 extending at least partially therethrough, which may be used to attach the optical position sensing assembly 130 to the surface of the display 110 or to an overlay or other component using appropriate fastener(s). In some embodiments, the body 202 of the unitized optical assembly 203 may include alignment notches 210, an alignment face and/or alignment flange(s) that can allow body 202 to be placed in proper alignment on the surface of the display 110, overlay or other component.

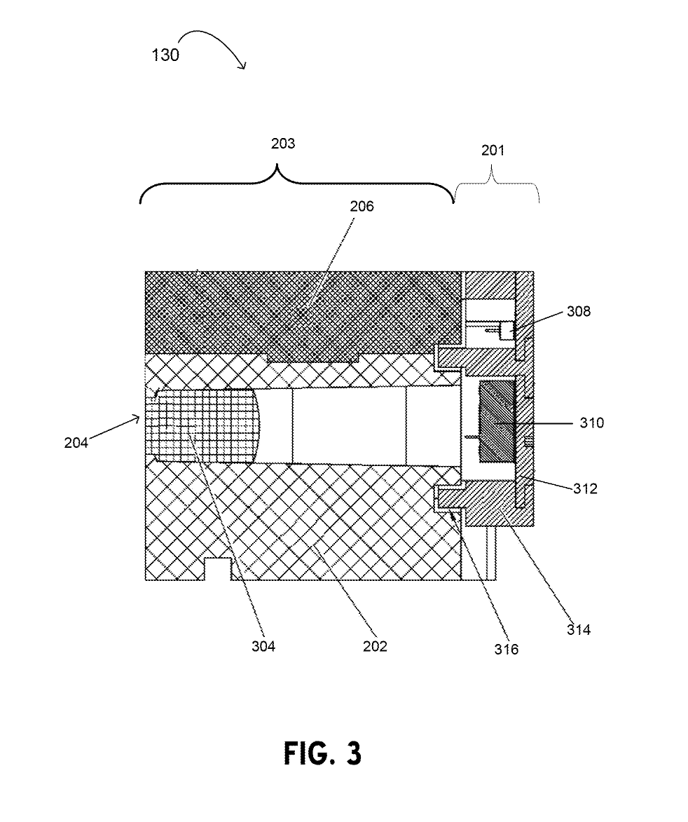

FIG. 3 depicts a side cross-sectional view of the exemplary optical position sensing assembly 130 of FIG. 2, taken along the line 3-3′, which bisects the center of the optical position sensing assembly 130. The various parts of the unitized optical circuit 201 and the unitized optical assembly 203 are more fully shown in FIG. 3. In particular, the figure shows the energy source 308, the sensor 310 and lead frame 312 of the unitized optical circuit 201. The figure also shows the single element lens 304 of the unitized optical assembly 203.

The unitized optical circuit 201 can be a chip package including the energy source 308, the sensor 310, and the lead frame 312. Integrating the sensor 310 and the energy source 308 into a unitized optical circuit 201 obviates the need for a separate flexible printed circuit board connecting the sensor 310 and the energy source 308. The energy source 308 may emit any suitable type of electromagnetic radiation 140, such as infrared or near-infrared energy. Alternately, the energy source 308 may emit ultra violet or visible light energy (e.g., at one or more frequencies, wavelengths, or spectrums). The energy source 308 may also include one or more separate emission sources (emitters, generators, etc.). In some embodiments, energy source 308 includes one or more LED's.

As described, the sensor 310 detects changes in electromagnetic radiation 140 reflected toward optical position sensing assembly 130, for example from an external reflector 107 or other energy source. The sensor 310 can be based on complementary metal oxide semiconductor (“CMOS”), charge coupled device (“CCD”), or charge injection device (“CID”) technologies, or any other sensor technology capable of detecting changes in electromagnetic radiation 140. The lead frame 312 is configured to physically support the energy source 308 and the sensor 310. The lead frame 312 can be fabricated from any material suitable for use in connection with integrated circuits, such as silicon or etched copper.

Overmolding 314 may be applied to the lead frame 312 in order to optically isolate the sensor 310 from the energy source 308 (once the unitized optical circuit 201 is attached to the unitized optical assembly 203). The lead frame 312 communicatively couples the unitized optical circuit 201 to another device via the lead frame connector 212. The lead frame 312 can include any suitable communication medium. In some embodiments the lead frame 312 can use copper leads as a communication medium.

In some embodiments, the unitized optical assembly 203 includes a single element lens 304. The single element lens 304 can be an aspherical lens, with an f-theta characteristic, which can be constructed from transparent plastic material or glass. The single element lens 304 can be formed within the body 202 of the unitized optical assembly 203 so as to create an imaging lens surface that is substantially flush with the aperture 204. Forming an imaging lens surface that it is substantially flush with aperture 204 eliminates the need for a separate window covering the aperture and can allow contaminants or liquids to be easily wiped from the imaging lens surface without being pushed into the aperture.

In some embodiments, the single element lens 304 may be formed from a relatively soft material, such as styrene. The imaging lens surface of single element lens 304 can be treated with a material that provides a hard coat film to reduce abrasion, e.g., by way of a physical vapor deposit (PVD) technique. The selected material used to coat the imaging lens surface of the single element lens 304 may also provide anti-reflection properties to the imaging lens surface. An example of such an anti-reflective coating material is a thin film wavelength filter.

For some applications, it may be desirable that the optical position sensing assembly 130 be configured to pass electromagnetic radiation 140 at a particular wavelength, such as infrared light, and reject electromagnetic radiation at other wavelengths, such as visible light. In certain embodiments, the optical position sensing assembly 130 may be so configured without the need to include a separate infrared pass filter component. For example, in some embodiments, the imaging lens surface of the single element lens 304 and/or the sensor 310 can be coated with a material that can filter electromagnetic radiation 140.

In other embodiments, the single element lens 304 and any other optically clear parts of the optical position sensing assembly 130 can be dyed with a dye or mixture of dyes that effectively filters electromagnetic radiation 140. For example, dyes are known in the art that act as long-wavelength pass filters so as to remove visible light, while passing infrared illumination. One example of such a dye is a visible opaque dye capable of absorbing light at wavelengths from 400 nm to 700 nm. The use of such a dye is ideal where 950 nm LED's are used in the energy source 308. In other implementations (e.g., when using 850 nm LED's) where it may be desirable to block wavelengths between 900 nm and 1100 nm, an optical notch dye or coating (e.g., centered at 950 nm) can be used. An example of such an optical notch dye is a near infrared dye, such as EPOLIGHT™ 4105.

When the unitized optical assembly 203 is coupled to the unitized optical circuit 201, the illumination window 206 is positioned in front of and aligned with the energy source 308 and the sensor 310 is aligned with the aperture 204. The unitized optical circuit 201 can be attached to the body 202 of the unitized optical assembly 203 using a light sealing material 316. The light sealing material 316 may be any suitable adhesive or sealant that can prevent light from entering the interior of optical position sensing assembly 130 through the junction points between the unitized optical assembly 203 and the unitized optical circuit 201.

The illumination window 206 is made from plastic or other suitable material (e.g., glass) and may be formed so as to largely fill the distance between the energy source 308 and the front plane of the optical position sensing assembly 130. The refractive index of the illumination window 206 foreshortens the apparent distance between energy source 308 and the front plane of optical position sensing assembly 130, producing similar optical effects as if the energy source 308 were positioned forward of the plane of the sensor 310 (i.e., closer to the aperture than the sensor 310), despite that fact that the energy source 308 may be positioned in substantially the same plane as the sensor 310 in the unitized optical circuit 201. As will be appreciated, the width of the illumination window 206 may be dictated by the illumination pattern of the energy source 308.

In some applications, the optimal position of the energy source 308 relative to the sensor 310 in the plane of the sensor 310 may depend on a combination of the refractive index of the illumination window 206, as well as the dimensions of the display 110 and the properties of the reflectors 107 used in the applicable optical position sensing system 100. For example, in optical position sensing systems 100 that employ high performance retroreflectors, it is generally desirable that the path of the emitted energy be as close to the aperture 204 as possible. For such applications, the energy source 308 may be positioned at an offset relative to an axis centered on and perpendicular to aperture 204. For example, the energy source 308 may be positioned close to a line that lies through aperture 204 from the most distant corner of the display 110 of the applicable optical position sensing system 100.

In four sensor optical position sensing systems 100, with optical position sensing assemblies 130 in all corners of a rectangular display 110, there is a need to maintain illumination substantially across each optical position sensing assembly 130 when viewed from the other optical position sensing assemblies 130. Designing the single element lens 304 to be substantially flush with the aperture 204, in accordance with embodiments of the present invention, allows the aperture 204 to be of minimal size (i.e., as small as a single pixel in size as viewed from the other optical position sensing assemblies 130). The minimal size of the aperture 204 in turn allows the reflectors 107 (e.g., (retroreflectors or light pipes) of the optical position sensing system 100 to be arranged so as to have a smaller gap of reflected illumination near the optical position sensing assembly 130 as compared to other existing designs. For example, in certain embodiments, retroreflective material can cover the entire front face of the optical position sensing assembly 130, except for the aperture 204 and the illumination window 206. Energy emitted from the illumination window 206 provides illumination (visible to the other optical position sensing assemblies 130) that would otherwise be lacking due to the gap in retroreflective material in front of the illumination window 206.

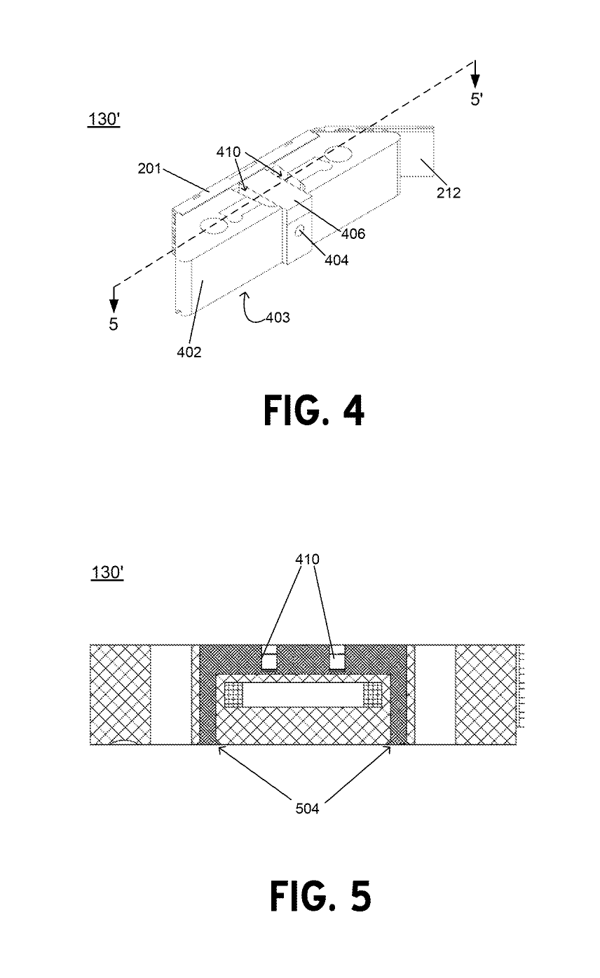

FIG. 4 depicts a simplified optical position sensing assembly 130′ according to certain alternative embodiments of the present invention. FIG. 5 depicts a cross-sectional view of the exemplary optical position sensing assembly 130′ shown in FIG. 4, taken along taken along the line 5-5′. The optical position sensing assembly 130′ shown in FIGS. 4 and 5 includes a unitized optical circuit 201 and a unitized optical assembly 403. The features of the unitized optical assembly 403 shown in FIGS. 4 and 5 are substantially similar to those of the unitized optical assembly 203 shown in FIGS. 2 and 3, except that the width of the illumination window 406 is significantly reduced in the embodiments of FIGS. 4 and 5. Alignment notches 504 are also included on the bottom of the optical position sensing assembly 130′ as opposed to the front face thereof.

A more narrow illumination window 406 can be achieved by creating a “light pipe” to convey electromagnetic radiation 140 from the energy source 308 (which is positioned in the plane of the sensor 310) through body 402 to the front plane of optical position sensing assembly 130′. A light pipe can be formed by adding light pipe edges 410 to the sides of the illumination window 406. The light pipe edges 410 may be formed from a material (e.g., high opacity plastic) positioned adjacent to the sides of the illumination window 406 and having a suitable index of refraction to cause the illumination window 406 to exhibit total internal reflection. Alternatively, the sides of the illumination window 406 may be coated with any suitable film or other material that achieves the same effect. As will be appreciated, the light pipe can be designed with internal reflective characteristics that cause electromagnetic radiation 140 to be emanated therefrom in a desired illumination pattern, such as an illumination pattern of substantially 90 degrees, without the need for a wider illumination window 206.

As mentioned, the body 202, single element lens 304, and illumination window 206 of the unitized optical assembly 203 can be constructed as a single co-molded unit. The body 202 can be formed from any suitable material, such as plastic. The single element lens 304 and the illumination window 206 can be formed from any material suitable for refracting electromagnetic radiation 140, including plastic or glass. In some embodiments, the materials used to form the body 202, the illumination window 206, and the single element lens 304 are selected such that they can be chemically bonded to one another. Chemical bonding can seal the unitized optical assembly 203 to prevent the ingress of liquids and other contaminants. For example, Polycarbonate/Acrylonitrile Butadiene Styrene (PC-ABS) for the opaque body parts and Styrene for the optically clear parts of the unitized optical assembly 203 have been found suitable. As will be appreciated by those of skill in the art, various mechanical retention features can also be designed into the body 202 to assist in coupling the unitized optical assembly 203 to the unitized optical circuit 201.

A unitized optical assembly 203 in accordance with certain embodiments of the present invention can be formed using injection molding. In some embodiments, injection molding may be twin shot. In such embodiments, a first injection shot can form the body 202. The body 202 will include cavities where the single element lens 304, the illumination window 206 and the light pipe edges (if applicable) will reside. The body 202 as molded during the first injection shot can also be formed with runners or gaps to provide access for a second injection shot. The second injection shot can form the single element lens 304, illumination window 206, and light pipe edges 410 (if applicable) within the applicable cavities in the body 202.

The unitized optical circuit 201 can be fabricated using any suitable packaging and assembly method for housing and interconnecting multiple components on a single circuit. In some embodiments, the unitized optical circuit 201 can be fabricated using wire-bonding chip-on-board technology. In other embodiments, the unitized optical circuit 201 can be fabricated using tape automated bonding chip-on-board technology. In still other embodiments, the unitized optical circuit 201 can be fabricated using flip chip-on-board technology. In some embodiments, the packaging and assembly method may apply overmolding 314 to the unitized optical circuit 201 in order to protect the components and the connections between them.

The foregoing description of the embodiments, including illustrated embodiments, of the invention has been presented only for the purpose of illustration and description and is not intended to be exhaustive or to limit the invention to the precise forms disclosed. Numerous modifications, adaptations, and uses thereof will be apparent to those skilled in the art without departing from the scope of this invention.

1. An optical position sensing assembly comprising:
a unitized optical assembly formed as a single component; and
a unitized optical circuit, wherein the unitized optical circuit is coupled to the unitized optical assembly.

2. The optical position sensing assembly of claim 1, wherein the unitized optical assembly comprises:
an opaque material defining a body, wherein at least a portion of the body defines an aperture and a cavity for receiving a single-element lens; and
wherein the single-element lens is injection-molded within the cavity of the body so as to form a single component, wherein the single-element lens comprises a lens material suitable for chemically bonding to the opaque material.

3. The optical position sensing assembly of claim 2, wherein at least a portion of the single-element lens is dyed so as to block visible light and pass infrared light.

4. The optical position sensing assembly of claim 2, wherein the single-element lens fills the cavity so as to form an imaging lens surface substantially flush with the aperture.

5. The optical position sensing assembly of claim 4, wherein the imaging lens surface is treated with a hard coating film.

6. The optical position sensing assembly of claim 4, wherein the imaging lens surface is coated with a substance capable of blocking visible light and passing infrared light.

7. The optical position sensing assembly of claim 2, wherein the unitized optical circuit comprises:
an energy source; and
a sensor directly connected to the energy source without using an intermediate printed circuit board.

8. The optical position sensing assembly of claim 7, further comprising an illumination window, the illumination window positioned between the energy source and a front plane of the optical position sensing assembly.

9. The optical position sensing assembly of claim 8, wherein the energy source is positioned at an offset to an axis centered on and perpendicular to the aperture.

10. The optical position sensing assembly of claim 8, wherein refractive properties of the illumination window foreshorten an apparent distance between the energy source and the front plane of the optical position sensing assembly.

11. The optical position sensing assembly of claim 10, wherein the illumination window comprises a light pipe capable of carrying energy from the energy source to the front plane of the optical position sensing assembly and emitting said energy in an illumination pattern of substantially 90 degrees.

12. The optical position sensing assembly of claim 7, wherein the sensor is coated with a substance capable of blocking visible light and passing infrared light.

13. An optical position sensing system comprising:
a touch area; and
an optical position sensing assembly adjacent the touch area, the optical position sensing assembly configured to detect interference with energy traveling in the touch area, the optical position sensing assembly comprising a unitized optical assembly formed as a single component, a sensor and an energy source.

14. The optical position sensing system of claim 13, further comprising:
a frame located around a perimeter of the touch area;
at least one reflector positioned on the frame for reflecting energy across the touch area; and
wherein the optical position sensing assembly is mounted to the frame and configured to detect interference with energy emitted from the energy source into the touch area and reflected by the at least one reflector.

15. The optical position sensing system of claim 14, further comprising:
a computing system comprising a processing unit, the processing unit interfaced to the optical position sensing assembly and configured to determine a position of a touch in the touch area.

16. The optical position sensing system of claim 15, wherein the sensor and the energy source are mounted on a unitized optical circuit attached to the unitized optical assembly.

17. A method for manufacturing a unitized optical assembly, the method comprising:
injection-molding a body from an opaque material, wherein at least a portion of the body defines an aperture and a cavity for receiving a single-element lens; and
injection-molding the single-element lens within the cavity of the body so as to form a single component, wherein the single-element lens comprises a lens material suitable for chemically bonding to the opaque material, and the single-element lens fills the cavity so as to create an imaging lens surface substantially flush with the aperture.

18. The method of claim 17, wherein the injection-molding steps are performed as a two shot molding process.

19. The method of claim 17, wherein the injection-molding steps are performed as an insert molding process.

20. The method of claim 17, wherein the body further defines a second cavity for receiving an illumination window; and
injection-molding the illumination window in the second cavity, the illumination window extending from the back to the front of the body.
